(19) United States
(12) Patent Application Publication
(10) Pub. No.: US 2003/0186738 A1
(43) Pub. Date: Oct. 2, 2003

(54) Method for providing a demand for skill

(76) Inventor: Matthias Schaufelberger, Bergdietikon (CH)

Correspondence Address: RANKIN, HILL, PORTER & CLARK, LLP, 700 HUNTINGTON BUILDING, 925 EUCLID AVENUE, SUITE 700, CLEVELAND, OH, 44115-1405, US

(21) Appl. No.: 10/333,304

(22) PCT Filed: Jul. 20, 2001
(86) PCT No.: PCT/CH01/00454

(30) Foreign Application Priority Data
Jul. 20, 2000 (CH) 1437/00

(51) Int. Cl. G06F 17/00

(52) U.S. Cl. 463/20

(57) ABSTRACT

According to the invention there is provided a skill requirement for gambling machines or slot machines in that a time account is set up in a prerequisite data set memory. Into this one feeds the quantitatively acquired results of a game of skill. The time account serves for the quantitative access authorisation to a gambling game, that is to say the more time present on the account, the longer or more varied is the user authorised for actuating the gambling machine

The invention relates to gambling machines or slot machines. It especially relates to a method for providing a skill requirement for gambling machines or slot machines, to a use of this method as well as to a device, to a gaming machine and to a use of a device, according to the preambles of the independent claims.

Roller gaming machines have a particular place of value amongst gambling machines or slot machines. Roller gaming machines have become known under the term “one-armed bandits” on account of the lever for operation which was then present. Roller gaming machines are in particular based on three rollers, on which of each there are attached a plurality of graphical motives distributed in the circumferential direction. At the same time there are equivalents of the motives on the three different rollers. When playing, the rollers rotate for a certain time, for example at different speeds. If the motives visible in a common display field—in each case one per roller—correspond to one another, or have a certain pattern then the player has won and obtains a multiple of his stake as winnings.

Such a roller gaming machine according to the state of the art offers a pure game of chance. This is unsatisfactory for many reasons. From many points of view, games of skill are more interesting and suitable, they are more exciting and are more fun, since one may influence one's own luck and in the case of success one also has a reason to be proud. Also with pure games of chance experienced players may not draw any advantages at all from their experience. Finally in legislation there is the tendency to prohibit pure chance gambling machines—probably also for the above reasons, and also on account of the danger of addiction. It would however be a shame and not practical if for the above reasons roller gaming machines and other gaming machines were to die out.

It is therefore the object of the invention to offer technical solutions to the above field of problems and in particular to provide a method, a use of this method and a device, which permit the full use and integration of the interesting attributes of a roller slot machine, video monitor slot machine or other slot machine, and despite this permit a game of skill at the same time.

This object is solved by the invention as is defined in the patent claims.

The invention is characterised essentially in that it makes available a prerequisite data set. e.g. a time account. This is provided with the quantitatively acquired results of a game of skill. The prerequisite data set serves as the input data set determining the playing possibilities for a money gambling machine.

In the following by way of the drawings there are described further preferred embodiment examples of the invention. In the drawings there are shown in:

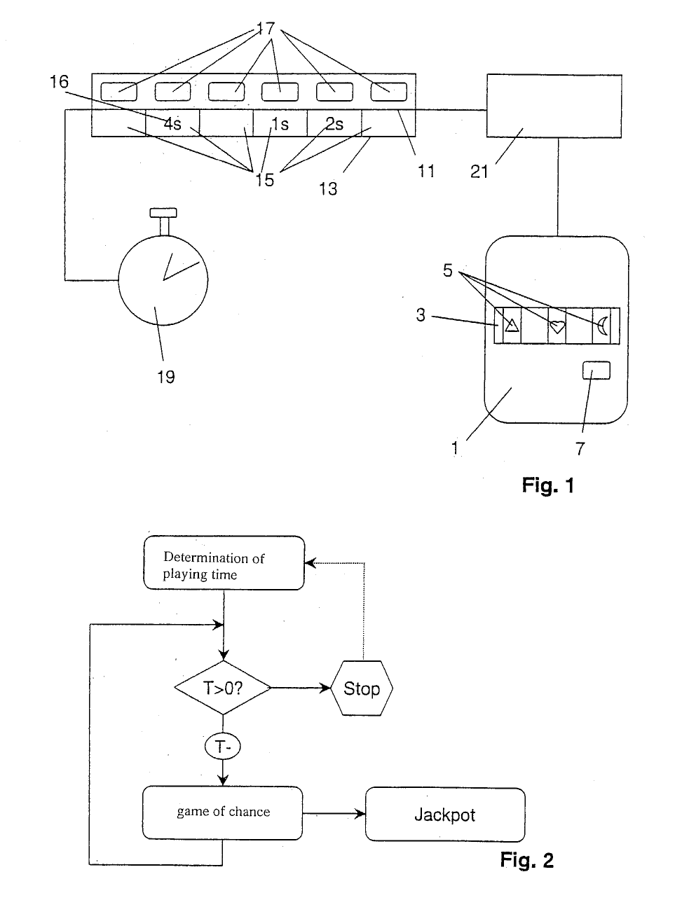

FIG. 1 a schematic representation of elements of a gaming machine and

FIG. 2 a schematic diagram of the procedure.

As is shown in FIG. 1 the gaming machine comprises a money gambling machine operating front surface 1. The version shown here relates to a roller machine, however one may just as well use any other money gambling machine known per se which is additionally provided with the features according to the invention, which are here described by way of example. On this front surface there is visible a display video 3, through which one may see a circumferential section of the three rollers, wherein on each roller a motive 5 is visible through the window. It may be the case that there are present more than three rollers. Operating elements 7 for the money gambling machine are additionally shown on the front surface.

In place of circumferential sections of actual rollers one may of course also select other representations. For example the projection of the symbols in several rows onto a transparent surface is known; in place of a rotation of the rollers there is then a movement of the rows in their longitudinal direction. Other symbolic representations of the rollers are also possible.

The gambling machine or slot machine according to the invention apart from these known features of money gambling machines further comprises a device for determining a prerequisite data set on account of a game of skill and for transmitting this data set to the money gambling machine. This device is preferably integrated with the money gambling machine in a single gaming machine. In this case an internal interface serves as a communication module for a connection between the device and the money gambling machine. By way of the fact that such a device, or with regard to software, is integrated into a money gambling machine, this then becomes a skill gaming machine. The device may also be applied externally and be connected to the money gambling machine via an external interface of a communication module. The device comprises an operating field 11 which preferably (and not shown in FIG. 1) is integrated into the front surface 1. The operating field has an alpha-numeric display 13 with display sectors 15. An operating button 17 is allocated to each display sector 15. In the shown example the operating button 17 is in each case located above the display sector 15, it may however be just as well arranged somewhere else and in particular the operating button may contain the display sector. The operating button also need not be a button in the true sense, it may be designed also as a touch surface of a touch sensor or as any other operating element. Furthermore the device comprises a timer 19 and a memory 21.

In the following the method is yet described, wherein one refers partly also to FIG. 2. The method is for example controlled by a computer program implemented with regard to software or hardware. In a first step, in the case that this has not already been effected, there is set up a time account. Such an account is designed for example as part of the electronic or magnetic data memory 21. The memory may also further be designed in a different manner, for example in the form of an optical data memory or also in the form of a magnetic memory (for example as a flywheel) amongst other things.

Subsequently the contents of the time account are determined (determining the playing time). This may be effected by a process which gives the user the possibility of a game of skill. In the example according to FIG. 1 this would run as follows:

On the alpha-numeric display 13 time details are shown up on several but not all randomly distributed display sectors 15. For example three display sectors 15 may in each case receive a time detail 16, e.g. 4 s, 2 s and 1 s in any distribution and sequence. One may proceed in that the time details are predetermined and the distribution of the time detail on the display sectors 15 are merely varied from use to use. The time details and also their number can just as well be varied from time to time; this may be effected according to the random principle or on account of predetermined parameters.

With the appearance of the time details on the alpha-numeric display the user receives the excercise of actuating the operating buttons allocated to the display sectors 15. For this, by way of the time-setting means, thus the timer, he has at his disposal a time interval beginning with the appearance of the time details. The time setting-means functions analogously to a stop-watch. A display field for the graphic or numerical representation of the time remaining to the user may also be present. If during the time interval the user operates an operating button which is allocated to a time detail, then the time amount appearing as a time detail is credited to the time account. If this is effected for more than one time detail, this is effected cumulatively, that is to say the time amounts are added.

The time details are faded out again after completion of the time interval. Simultaneously the end of the time interval may be signaled to the user by way of an acoustic and/or optical signal (e.g. a “traffic” light may switch to red). The operating buttons are deactivated, i.e. a further actuation has no consequences.

Apart from the previously described, preferred method there are yet further possible procedures for determining the content of the time account. Thus for example a sequence of illuminating sectors may appear on the operating field. The user then in the same sequence must operate the operating buttons allocated to the sectors. The further he gets with this, i.e. the quicker and more skillfully he operates the buttons, the more is his time account credited. One may also provide a sequence of reaction tests with reaction times which become smaller and smaller; the longer the user keeps up with this and fullfills the demands, the more time he receives on his account. Alternatively or additionally to this one may also test the accuracy of the user instead of his reaction capability. For determining the content of the time account indeed any method suitable for machines and used for games of skill may be employed, wherein here with regard to this one refers to the comprehensive state of art.

The time account in a next step is used as a quasi-quantative access authorisation to the gambling game. Such a game may be carried out for example with a roller machine discussed previously or any other gambling machine. Instead of an amount of money—the more one pays, the more one may play and try his luck—the time account authorises access to the gaming machine. The user may play as long as his time account has not been used up (T>0). The time is deducted from the account during the active playing phases (T−).

The time account may be managed differently during a gambling game. Thus for example each game round may be selected in a uniform length, the time account then fixedly sets the number of playing rounds. Alternatively to this it may also be provided for the player to be able to determine the length of a round of a game. For example with a roller machine the rotational speed of the rollers may be reduced in comparison to standard roller machines so that a skillful player may recognise a sequence and accordingly may determine a favourable point in time to stop the rollers. The longer he wishes to wait, the more time is deducted from the time account. One may also envisage for a part of the time account to be able to be used for special game features, for example for resetting the winning conditions or for determining or increasing the maximum winnings.

Finally it is yet to be mentioned that the above described example of course represents only one possibility of realising the method according to the invention, and still further embodiment forms belong to the invention. In particular it is not necessary for the prerequisite data set to have the form of a time account. A point account or a start-number account may just as easily be provided. A certain number of points authorises one or more operations. For example one possibility is for a game to be carried out per certain number of points. Furthermore one may also provide points for effecting simplifications of the game, for increased winning chances, as a bonus, as a joker, etc.

The gambling machine or slot machine may be implemented in the most varied of manners. Here the implementation of a video game machine is additionally specially one of the previously discussed possibilities.

1. A method for providing a skill requirement for gambling machines or slot machines, characterised by the following method steps:
setting up a prerequisite data set memory (21),
carrying out a game of skill with results which may be acquired quantitatively,
converting the results into a quantitative prerequisite data set,
incorporating the results of this prerequisite data set into the data set memory,
carrying out a gambling game using the prerequisite data set,
wherein the prerequisite data set quantitatively determines the possibilities for playing the gambling game, and wherein with a zero result in the game of skill essentially no authorisation to the gambling game is given.

2. A method according to claim 1, characterised in that there exists a representation of the prerequisite data set by way of a number, that a zero result of the game of skill in the representation of the prerequisite data set is represented by the number zero, that furthermore a result of the game of skill which is different to zero is represented by a positive number, wherein a prerequisite data set represented by zero does not authorise a gambling game.

3. A method according to claim 2, characterised in that the prerequisite data set lies in a time made available for the gambling game and that the representation by a number is the number of seconds available or that the prerequisite data set lies in the number of gambling game rounds to which a user is authorised.

4. A method according to one of the preceding claims, characterised in that there is present an operating field (11) with a display (13), said display (14) comprising several display sectors (15), wherein the operating field (11) comprises an operating button (17) for each display sector (15), that during a time interval monitored by time setting means (19) quantitative winning details appear on several display sectors (15) and that the result of the game of skill is formed by the sum of the winning details appearing in the display sectors (15) for which winning details a user within the time period has actuated the operating button (17) allocated to the display sector (15).

5. The use of the method according to one of the preceding claims for determining a quantitative access authorisation to gambling machines.

6. A device for determining a prerequisite data set and for transmitting this data set further to gaming machines or a gambling module of a gaming machine, characterised by means for carrying out a game of skill with a quantitatively acquirable result, by memory means (21) for storing this result, by a communication module for transmitting these results to the gaming machine and with means for carrying out the method according to one of the claims 1 to 4.

7. A device according to claim 6, characterised in that the means for carrying out a gambling game comprise an operating field (11) with a display (13) and operating buttons (17), time-setting means (19), control means for the time setter and the display, and a data processing program implemented with regard to software or hardware which comprises a program code by way of which after activation control means are activated into displaying information on the display and for detecting operating button impulses during a time interval determined by the time setting means.

8. A gaming machine with a gambling machine for carrying out a gambling game in dependence of a quantitative access authorisation as a prerequisite data set, characterised by a device according to claim 6 or 7 for determining the prerequisite data set and for transmitting this data set to the gambling machines.

9. The use of a device for carrying out a game of skill with results which can be quantitatively acquired, for determining a prerequisite data set for a gambling machine in a manner such that the prerequisite data set quantitatively determines the possibilities of playing the gambling game, and that with a zero result in the game of skill essentially no authorisation to the gambling game is given.
